(19) United States
(12) Patent Application Publication
(10) Pub. No.: US 2008/0287004 A1
(43) Pub. Date: Nov. 20, 2008

(54) Card connector

(75) Inventors: Osamu Miyamoto, Tokyo (JP); Koichi Kagotani, Tokyo (JP)

Correspondence Address: KUBOTERA & ASSOCIATES, LLC, Suite 202, 200 Daingerfield Road, Alexandria, VA, 22314, US

(73) Assignee: Hirose Electric Co., Ltd.

(21) Appl. No.: 12/149,817

(22) Filed: May 8, 2008

(30) Foreign Application Priority Data
May 15, 2007 (JP) 2007-129331

(51) Int. Cl. H01R 13/62

(52) U.S. Cl. 439/345

(57) ABSTRACT

A card connector includes a base, a cover, a detection switch, and a plurality of contacts for contacting with a card. The cover is pivotally supported on one end portion of the base to be freely rotatable. Further, the cover has a card receptacle portion to insert and remove a card, and is horizontally slidable along the base with the card retained in the card receptacle portion. The detection switch detects whether the card is inserted into the card connector when the cover horizontally slides along the base toward the one end portion of the base, and the detection switch contacts with the card horizontally sliding along with the cover.

### BACKGROUND OF THE INVENTION AND RELATED ART STATEMENT

The present invention relates to a card connector. More specifically, the present invention relates to a card connector having a card detection switch that can detects whether or not a card is loaded.

A variety of types of card connectors has been used to connect a card device such as a SIM card or a SD card to a device body such us a cellular phone, a personal computer, a PHD or the like. For example, there is a card connector in which a card is inserted through what is called a push-push operation. Further, there is a card connector in which a card is inserted through a cover having a card receptacle portion for inserting the card.

Patent Reference has disclosed a conventional card connector having a card receptacle portion. The card connector disclosed in Patent Reference mainly comprises a base, a cover, a contact, a first switch portion, and a second switch portion. The cover is pivotally supported by the base to be freely rotatable and has a card receptacle portion for the card to be inserted to or removed from. The contact can be electrically connected with the card.

The first switch portion can be displaced to contact the card when the cover that stores the card is situated with an angel of approximately 0 degree with respect to the base. The second switch portion is arranged to be adjacent to the first switch portion and contacts the first switch portion to be conducted when the first switch portion is displaced.

Specifically, when the cover is situated with an angle of approximately 0 degree with respect to the base, only the cover horizontally slides along the base while a position of the card with respect to the base is fixed. Further, whether the covers slides or not, when the cover that stores the card is situated with an angle of approximately 0 degree with respect to the base, the first switch portion and the second switch portion contact each other to be conducted. Accordingly, it is possible to determine whether or not the card is inserted in the connector through a conduction state between the second switch portion and the second switch portion.

Patent Reference: Japanese Patent Publication No. 2003-86302

In the card connector of the push-push type described above, it is necessary to form a hole in a device body (e.g. cellular phone) for inserting or removing a card, thereby increasing a cost to provide the hole. Further, when such a hole is formed in a device body, the hole may deteriorate an appearance of the device body.

In Patent Reference, the card connector has the card receptacle portion. Accordingly, it is possible to disposed the card connector, for example, in a hole that stores a battery, thereby solving a problem of the connector of the push-push type as described above.

However, in the card connector disclosed in Patent Reference, when the card is directly placed on, for example, the base instead of the cover retaining portion upon use, the card detection switch may erroneously detect the card placed on the base.

In the view of the problems described above, an object of the present invention is to provide a card connector in which a card detection switch does not detect a card when the card is erroneously inserted.

Further objects and advantages of the invention will be apparent from the following description of the invention.

### SUMMARY OF THE INVENTION

In order to attain the objects described above, according to the present invention, a card connector comprises a base, a cover, a detection switch, and a plurality of contacts for contacting with a card. The cover is pivotally supported on one end portion of the base to be freely rotatable. Further, the cover has a card receptacle portion to insert and remove a card, and is horizontally slidable along the base with the card retained in the card receptacle portion. The detection switch detects whether the card is inserted into the card connector when the cover horizontally slides along the base toward the one end portion of the base, and the detection switch contacts with the card horizontally sliding along with the cover.

In the card connector of the present invention, the detection switch may include a first switch portion and a second switch portion. The first switch portion can contact with the card to be displaced. The second switch portion can contact and conduct with the first switch portion when the first switch portion is displaced. Accordingly, it is possible to determine whether the card is inserted into the card connector from a conduction state between the first switch portion and the second switch portion.

In the card connector of the present invention, the first switch portion may be arranged such that the first switch portion contacts with the card on a pivotally support side of the cover with respect to the base in a horizontal slide direction thereof.

In the card connector of the present invention, an erect portion may be provided on an edge of the pivotally support side of the cover to erect toward the base.

In the present invention, the card connector may retain a card provided with a narrow width portion, a wide width portion, and a step portion along the horizontal slide direction thereof. The narrow width portion extends in a direction perpendicular to the horizontal slide direction on a side where the first switch portion contacts with the card. The wide width portion extends in a direction perpendicular to the horizontal slide direction on a side opposite to the side where the first switch portion contacts with the card. The step portion is formed on a side surface of the card by a difference between lengths of the narrow width portion and the wide width portion in a direction perpendicular to the horizontal slide direction.

In the card connector of the present invention, the first switch portion may be arranged near the step portion to be movable in a horizontal direction or a vertical direction. Accordingly, when the card retained in the card receptacle portion horizontally slides with the cover along the base, the step portion of the card contacts with the first switch portion, so that the first switch portion conducts with the second switch portion.

In the card connector of the present invention, a protruding portion may be provided on an inner surface of the cover along the horizontal slide direction. The protruding portion has a length in the horizontal slide direction larger than a length thereof in a direction perpendicular to the horizontal slide direction.

In the card connector of the present invention, a circular hole and a long groove may be provided toward the contact portion of the card and the first switch portion in the horizontal slide direction. The circular hole is provided in an outer surface of the base along the horizontal slide direction. The circular hole has a diameter large enough for the protruding portion of the cover to rotate. The long groove is connected to the circular hole, and has a diameter smaller than that of the circular hole. Further, the long groove has a diameter large enough for the protruding portion of the cover to slide in the horizontal direction.

Accordingly, the cover is pivotally supported with respect to the base to be freely rotatable when the protruding portion of the cover is positioned in the circular hole of the base. Further, the cover can be horizontally slidable with the card along the base when the cover is situated with an angle of approximately 0 degree or 180 degrees with respect to the base.

In the card connector of the present invention, an inclined surface may be provided in the base. When the cover is pivotally supported at nearly an angle of 90 degrees with respect to the base, the inclined surface contacts with the erect portion of the cover near a distal end portion thereof to maintain the angle of the cover with respect to the base.

In the card connector of the present invention, when the cover is pivotally supported at an angle other than approximately 0 degree and 180 degrees with respect to the base, the protruding portion of the cover and the circular hole of the base are preferably arranged such that the cover is situated closer to the contact portion of the card and the first switching portion with respect to the long groove of the base in the horizontal slide direction. Further, when the card that is not retained in the card receptacle portion, it is preferred that the card contacts with an inner surface of the cover on a side of the base, and does not reach the contact portion of the card and the first switch portion.

In the card connector of the present invention, when the cover is pivotally supported at an angle of approximately 180 degree with respect to the base, the protruding portion of the cover and the circular hole of the base are preferably arranged such that the cover is situated in the long groove of the base closer to the contact portion of the card and the first switching portion by a length of the protruding portion in the horizontal slide direction. Further, when the card that is not retained in the card receptacle portion, it is preferred that the card contacts with the erect portion erecting for a specific height, and does not contact with the contact portion of the first switch portion.

In the card connector of the present invention, the cover may be provided with a groove hole instead of the protruding portion. Further, the base may be provided with the protruding portion instead of the circular hole and the long groove.

In the card connector of the present invention, it is preferably arranged that the cover locks to the base when the cover slides horizontally along the base toward the contact portion of the card and the first switch portion while pivotally supported at an angle of approximately 0 degree with respect to the base.

### BRIEF DESCRIPTION OF THE DRAWINGS

FIG. 1 is a perspective view showing a card connector according to a first embodiment of the present invention;

FIG. 2 is a plan view showing the card connector according to the first embodiment of the present invention;

FIG. 3 is a plan view showing an inner configuration of the card connector according to the first embodiment of the present invention;

FIG. 4 is a perspective view showing the card connector in a state that a hinge cover rotates at an angle of approximately 45 degrees with respect to a base according to the first embodiment of the present invention;

FIG. 5 is a perspective view showing the card connector in a state that a card is inserted into the hinge cover inclined at an angle of approximately 45 degrees with respect to the base according to the first embodiment of the present invention;

FIG. 6 is a sectional view of the card connector according to the first embodiment of the present invention taken along a line 6,7-6,7 in FIG. 2 in a state that the hinge cover is locked to the base;

FIG. 7 is a sectional view of the card connector according to the first embodiment of the present invention taken along a line 6,7-6,7 in FIG. 2 in a state that the hinge cover is locked to the base (in a rotatable state);

FIGS. 8(a) and 8(b) are views showing the card connector before the hinge cover is completely locked to the base according to the first embodiment of the present invention, wherein FIG. 8(a) is a plan view of the card connector with a card inserted therein and without the hinge cover, and FIG. 8(b) is a side view of the card connector without the card;

FIGS. 9(a) and 9(b) are views showing the card connector in a state that the hinge cover is completely locked to the base according to the first embodiment of the present invention, wherein FIG. 9(a) is a plan view of the card connector with the card inserted therein and without the hinge cover, and FIG. 9(b) is a side view of the card connector without the card;

FIG. 10 is a side view showing a detection switch portion according to a second embodiment of the present invention;

FIGS. 11(a) and 11(b) are views No. 1 showing the card connector in an operation state according to the embodiment of the present invention, wherein FIG. 11(a) is a perspective view of the card connector, and FIG. 11(b) is a sectional view of the card connector taken along a centerline thereof in FIG. 11(a);

FIGS. 12(a) and 12(b) are views No. 2 showing the card connector in the operation state according to the embodiment of the present invention, wherein FIG. 12(a) is a perspective view of the card connector, and FIG. 12(b) is a sectional view of the card connector taken along the centerline thereof in FIG. 12(a);

FIGS. 13(a) and 13(b) are views No. 3 showing the card connector in the operation state according to the embodiment of the present invention, wherein FIG. 13(a) is a perspective view of the card connector, and FIG. 13(b) is a sectional view of the card connector taken along the centerline thereof in FIG. 13(a); and

FIGS. 14(a) and 14(b) are views No. 4 showing the card connector in the operation state according to the embodiment of the present invention, wherein FIG. 14(a) is a perspective view of the card connector, and FIG. 14(b) is a sectional view of the card connector taken along the centerline thereof in FIG. 14(a).

### DETAILED DESCRIPTION OF PREFERRED EMBODIMENTS

Hereunder, embodiments of the present invention will be explained with reference to the accompanying drawings.

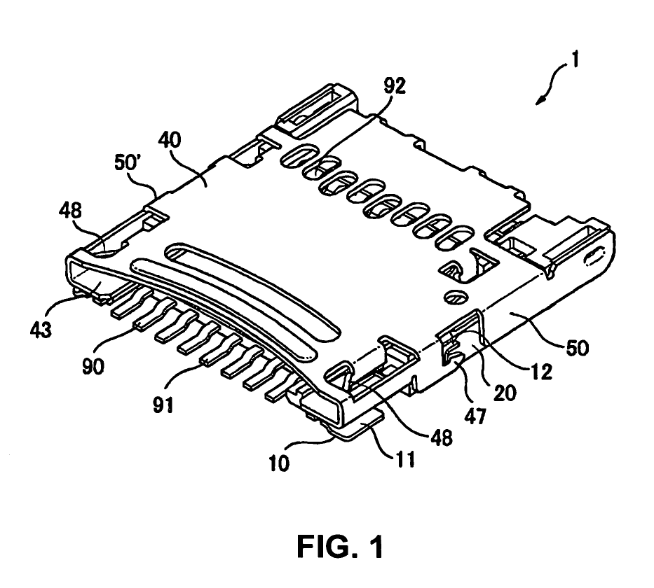

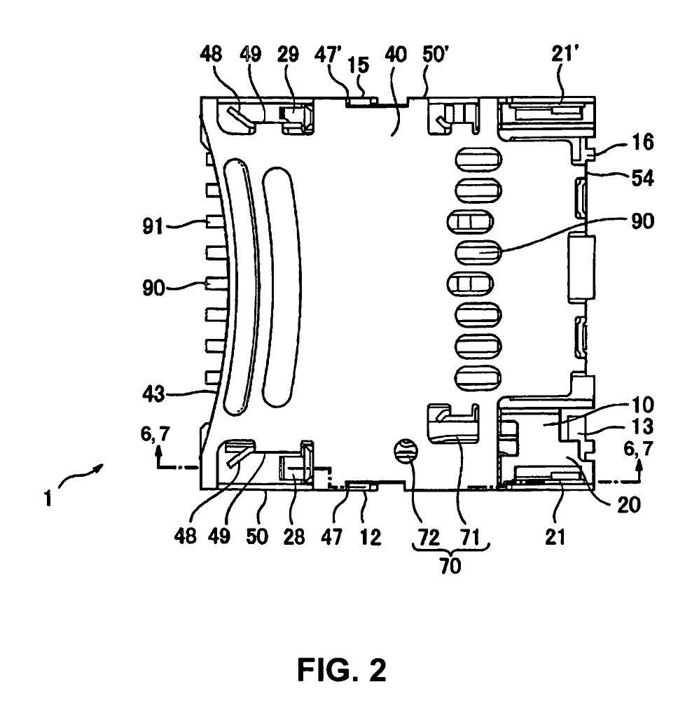

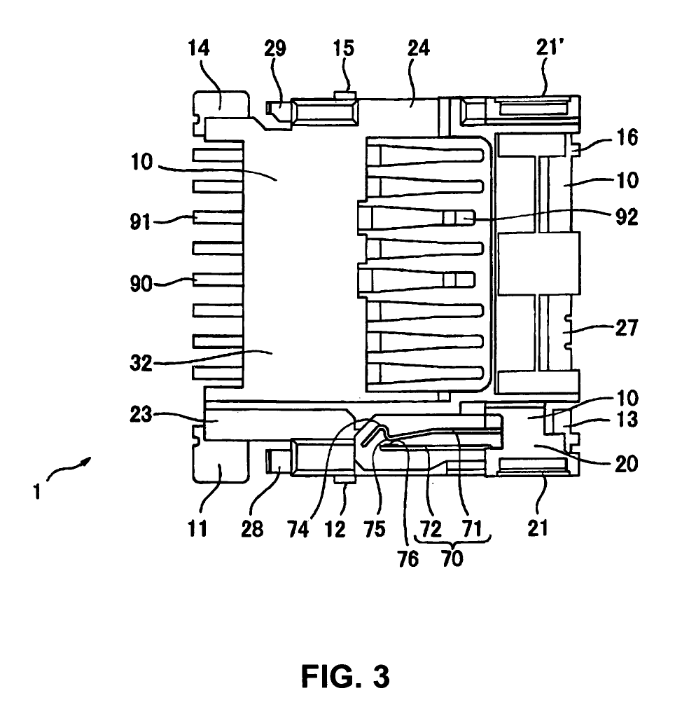

A first embodiment of the present invention will be explained with reference to FIGS. 1 to 9. FIG. 1 is a perspective view showing a card connector 1 according to the first embodiment of the present invention. FIG. 2 is a plan view showing the card connector 1 according to the first embodiment of the present invention. FIG. 3 is a plan view showing an inner configuration of the card connector 1 according to the first embodiment of the present invention.

In the first embodiment, the card connector 1 can be fixed inside of a device body for use. For example, when the device body is a cellular phone, the card connector 1 can be fixed to a grooved recess in a state as shown in FIGS. 1 and 2. The grooved recess is provided in a back of a battery mounting portion that is provided inside of the cellular phone.

When the card connector 1 is fixed inside of the cellular phone, the card connector 1 is not exposed outside of the device body in a normal use state. Accordingly, an appearance of the device body is not disfigured.

In the embodiment, the card connector 1 mainly comprises a base 10, a hinge cover 40, a plurality of a contact 90, and a detection switch 70. The hinge cover 40 is pivotally supported by the base 10 and has a card receptacle portion 42 in which a card is inserted into and removed from. The plurality of the contact 90 is fixed to the base 10 and is electrically contacted with a specific portion of the card that is inserted into the hinge cover 40.

Further, the detection switch 70 (shown in FIG. 3 etc.) detects whether or not the card is loaded. The detection switch 70 then sends an electrical signal to the device body to transmit a state of the card (whether or not the card is loaded); thereby, for example, manipulating the data of the card is restricted or allowed.

That is, the detection switch 70 effectively prevents an inappropriate manipulation of the card. Further, a detection result of the detection switch 70 can be displayed on a specific portion of the device body to warn a user. For example, the detection result can be displayed on a display of the cell phone.

In the embodiment, the base 10 constitutes a base of the card connector 1. The base 10 includes a housing portion 20 and a metal portion. The housing portion 20 is made of, for example, an insulation member such as a resin. The metal portion is integrally molded into the housing portion 20. The metal portion comprises three groups that are electrically disconnected. The base 10 can be fixed to a circuit board (not shown) of the device body with solder or the like through a circuit board mounting portion. The circuit board mounting portion is included in each of the three groups.

In the embodiment, each of the three groups is formed through punching, cutting, and bending a sheet of metal. The first group comprises a front circuit board mounting portion 11, a rear circuit board mounting portion 13, a first switch portion 71, a locking piece 12, a locking piece 28, and a cover mounting portion 21.

The front circuit board mounting portion 11 is a portion that is integrally molded into an arm portion 23 of one side of the housing 20. Further, the front circuit board mounting portion 11 has a relatively large mounting surface in a front portion of the base 10. The rear circuit board mounting portion 13 has a mounting surface in a rear of the base 10.

The first switch portion 71 is a part of the detection switch 70. The locking piece 12 is disposed in a hollow state with respect to the circuit board to lock the hinge cover 40. Similarly, the locking piece 28 is disposed in a hollow state with respect to the circuit board to lock the hinge cover 40. Further, the cover mounting portion 21 is provided on a rear outer surface of the base 10.

A metal portion of the second group has a rear circuit board fixing portion 27 and a second switch portion 72. The rear circuit board fixing portion 27 has a relatively large mounting surface in a rear of the base 10. The second switch portion 72 constitutes a part of the detection switch 70 along with the first switch portion 71 of the first group.

A metal portion of the third group has a front circuit board fixing portion 14 and a rear circuit board fixing portion 16. The front circuit board fixing portion 14 is a portion that is integrally molded into the arm portion 24 of the other side of the housing portion 20 and has a relatively large mounting surface in a front portion of the base 10. The rear circuit board fixing portion 16 has a relatively large mounting surface in the rear of the base 10.

Further, the metal portion of the third group includes a locking piece 15, a locking piece 29, and a cover mounting portion 21′. The locking piece 15 is used as a pair with the locking piece 12 of the first group and is disposed in a hollow state with respect to the circuit board to lock the hinge cover 40. Similarly, the locking piece 29 is used as a pair with the locking piece 28 of the first group and is disposed in a hollow state with respect to the circuit board to lock the hinge cover 40. The cover mounting portion 21′ is provided on a rear outer surface of the base 10.

In the embodiment, the contact 90 is integrally molded into a relay portion 32. The relay portion 32 connects the arm portions 23 and 24. One end portion of the contact 90 is used as a circuit board fixing portion 91. Similar to the circuit board fixing portion 91, the one end portion of the contact 90 is fixed to the circuit board with solder or the like.

The other end portion of the contact 90 is formed as a card contact portion 92 that brings the contact 90 into contacts with a pad portion (not shown) of a card 100. The card contact portion 92 is displaced toward the card receptacle portion 42 of the hinge cover 40 in some degree in order to ensure the contact with the card 100.

The hinge cover 40 is pivotally supported to be freely rotatable with respect to the base 10. Further, the hinge cover 40 is horizontally slidable with respect to the base 10 when pivotally supported at a specific angle.

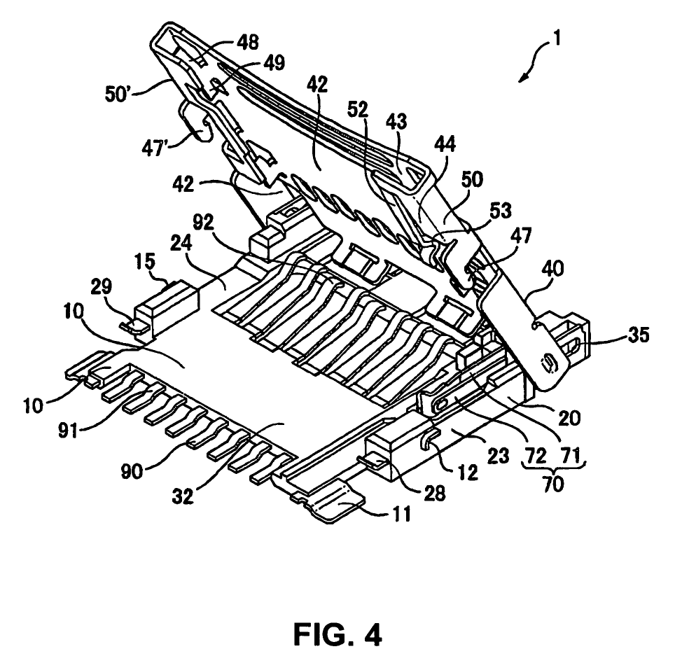

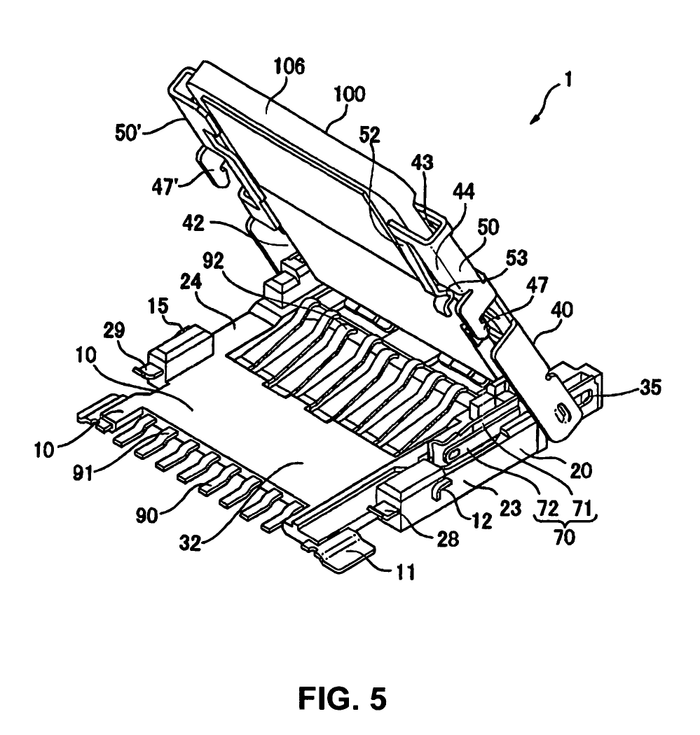

Examples of the rotation are shown in FIGS. 4 and 5. FIG. 4 is a perspective view showing the card connector 1 in a state that the hinge cover 40 rotates at an angle of approximately 45 degrees with respect to the base 10 according to the first embodiment of the present invention. FIG. 5 is a perspective view showing the card connector 1 in a state that the card 100 is inserted into the hinge cover 40 at an angle of approximately 45 degrees with respect to the base 10 according to the first embodiment of the present invention.

In the embodiment, a rotatable range is approximately 360 degrees before the circuit board is mounted. The rotatable range becomes approximately 180 degrees after the circuit board is mounted since the circuit board interrupts the rotation.

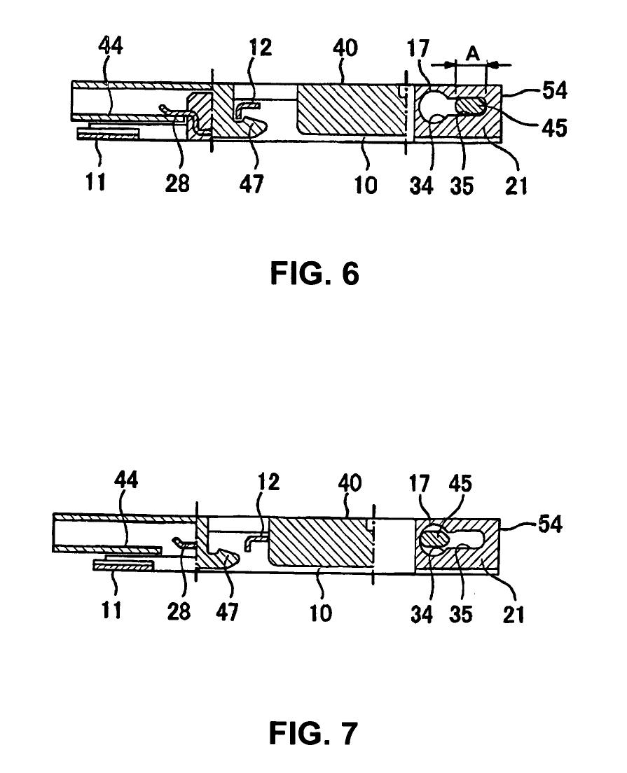

FIG. 6 is a sectional view of the card connector 1 taken along a line 6,7-6,7 in FIG. 2 in a state that the hinge cover 40 is locked to the base 10 . FIG. 7 is a sectional view of the card connector 1 taken along a line 6,7-6,7 in FIG. 2 in a state that the hinge cover 40 is locked to the base 10 (in a rotatable state). Note that FIG. 1 corresponds to a lock state shown in FIG. 6.

The card 100 is inserted into the hinge cover 40 through an insertion and removal slot 43. The insertion and removal slot 43 is provided on the opposite side of the pivotally support side of the hinge cover 40. A guide portion 48 is provided in the insertion and removal slot 43 for an easier insertion. A guide plate 49 is provided in a continuous state with the guide portion 48 so that the position of the card 100 with respect to the hinge cover 40 after the insertion is determined with ease.

The hinge cover 40 is horizontally slidable along the base 10 in a state in which the card 100 is inserted into the hinge cover 40 and the hinge cover 40 is rotated to be approximately 0 degree, a cover close state, with respect to the base 10. Accordingly, the hinge cover 40 can be locked to or unlocked from the base 10.

As described below in more detail, the card connector 1 according to the embodiment of the present invention can detect an insertion state of the card especially when the hinge cover 40 is locked with respect to the base 10.

In the embodiment, the base 10 pivotally supports the hinge cover 40, so that the hinge cover 40 is freely rotatable with respect to the base 10. Groove holes 17 and 17′ are provided to face each other in the cover mounting portions 21 and 21′ of the base 10, respectively, so that the base 10 pivotally supports the hinge cover 40. Further, a pair of protruding portions 45 and 45′ is provided to face each other on sidewalls of the distal side of the hinge cover 40 to correspond to the groove holes 17 and 17′, respectively, so that the base 10 pivotally supports the hinge cover 40.

In the embodiment, the protruding portions 45 and 45′ protrude inward toward an inner surface. The groove holes 17 and 17′ of the base 10 are provided in a rear outer surface of the base 10. The groove holes 17 and 17′ include circular holes 34 and 34′ and long grooves 35 and 35′, respectively.

The circular holes 34 and 34′ are situated on a slightly front side of the base 10. The long grooves 35 and 35′ are in a continuous state with a rear side of the circular holes 34 and 34′, respectively. The long grooves 35 and 35′ are formed along a horizontal slide direction in a direction toward the contact portion (74) of the card 100 and the first switch portion 71, or in other words, a backward direction toward a pivotally support side of the hinge cover 40 with respect to the base 10 in the horizontal slide direction.

The protruding portions 45 and 45′ of the hinge cover 40 are provided in the corresponding circular holes 34 and 34′ and the long grooves 35 and 35′, respectively, of the base 10. Accordingly, the hinge cover 40 rotates in front of the rear edge with respect to the base 10.

Further, the hinge cover 40 is pivotally supported to be horizontally slidable from the rotation position to the rear position. The groove hole 17′, the protruding portion 45′, the circular hole 34′, and the long groove 35′ (not shown) are provided in the same size and shape in the opposite position of the groove hole 17, the protruding portion 45, the circular hole 34, and the long groove 35, respectively.

In the embodiment, a length of the protruding portions 45 and 45′ of the hinge cover 40 in a horizontal slide direction is set to be longer than that in a direction perpendicular to the horizontal slide direction, so that the hinge cover 40 can slide as well as rotate.

Each of the circular holes 34 and 34′ of the base 10 is provided to have an enough diameter for each of the protruding portions 45 and 45′ of the hinge cover 40 to be rotated. Further, diameters of the long grooves 35 and 35′ of the base 10 are provided to be smaller than those of the circular holes 34 and 34′ and large enough for the protruding portions 45 and 45′ of the hinge cover 40 to slide in a horizontal direction, respectively.

The dimensions are determined as described so that the base 10 pivotally supports the hinge cover 40 to be freely rotatable 360 degrees near the circular holes 34 and 34′. More specifically, when the hinge cover 40 forms approximately 0 degree or 180 degrees with respect to the base 10, the hinge cover 40 is slidable along the base 10 in a horizontal direction along with the card 100.

It is preferred that the hinge cover 40 be produced through punching, cutting, and bending a sheet of metal plate. Specifically, an erect portion 54 is provided on a distal side (pivotally support side) edge of the hinge cover 40. The erect portion 54 is bent to erect toward the base 10. The erect portion 54 forms a receptacle surface portion to receive a distal portion of the card 100 that is inserted into the card receptacle portion 42. Further, the erect portion 54 is used to maintain a rotation angle of the hinge cover 40 or to prevent a switching error that will be described later.

In the embodiment, hook portions 47 and 47′ that are facing each other are provided to correspond to the locking pieces 12 and 15 of the base 10, respectively, on the respective sidewalls 50 and 50′ on both sides near a middle portion of the hinge cover 40 in order to lock the hinge cover 40 to the base 10. The hook portions 47 and 47′ are disposed to face each other and are extended toward a contact portion (74) of the card 100 and the first switch portion 71 in a horizontal slide direction.

In the embodiment, a pair of locking plates 44 and 44′ that extend in a horizontal direction is provided at a front side of the hinge cover 40. Each of the locking plates 44 and 44′ is in an extended state from the sidewalls 50 and 50′, respectively, and is bent perpendicularly on the card receptacle portion 42 to correspond to the locking pieces 28 and 29 of the base 10, respectively.

The locking plates 44 and 44′ along with the erect portion 54 or the like can form a space for the card receptacle portion 42. The locking plate 44 of one side is provided with a card locking piece 52. The card locking piece 52 extends along a card insertion direction from an insertion side of the hinge cover 40 to the pivotally support side.

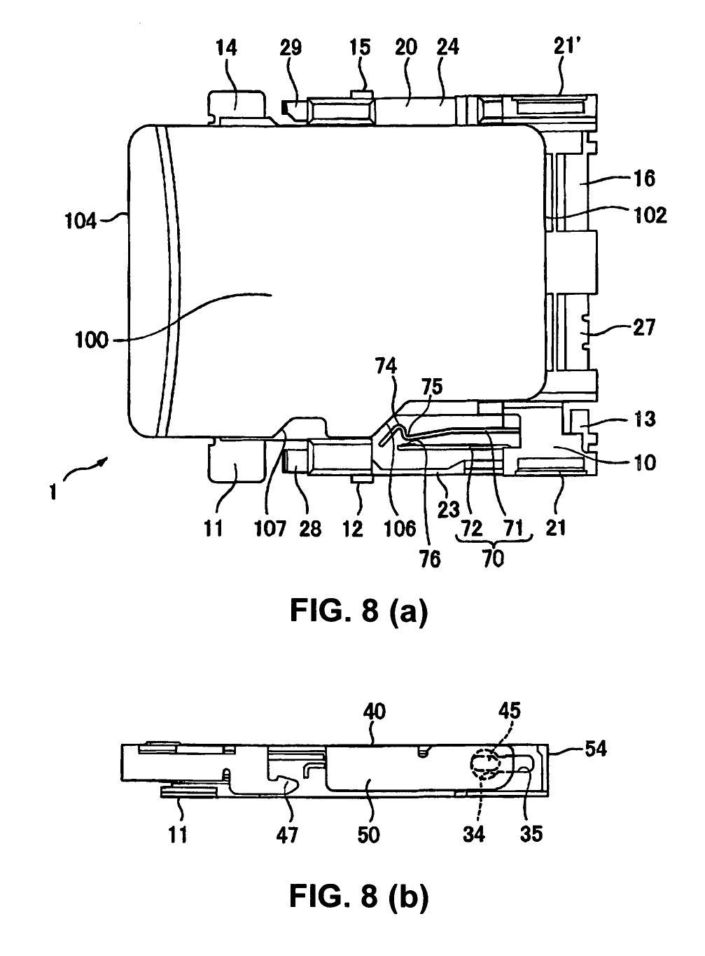

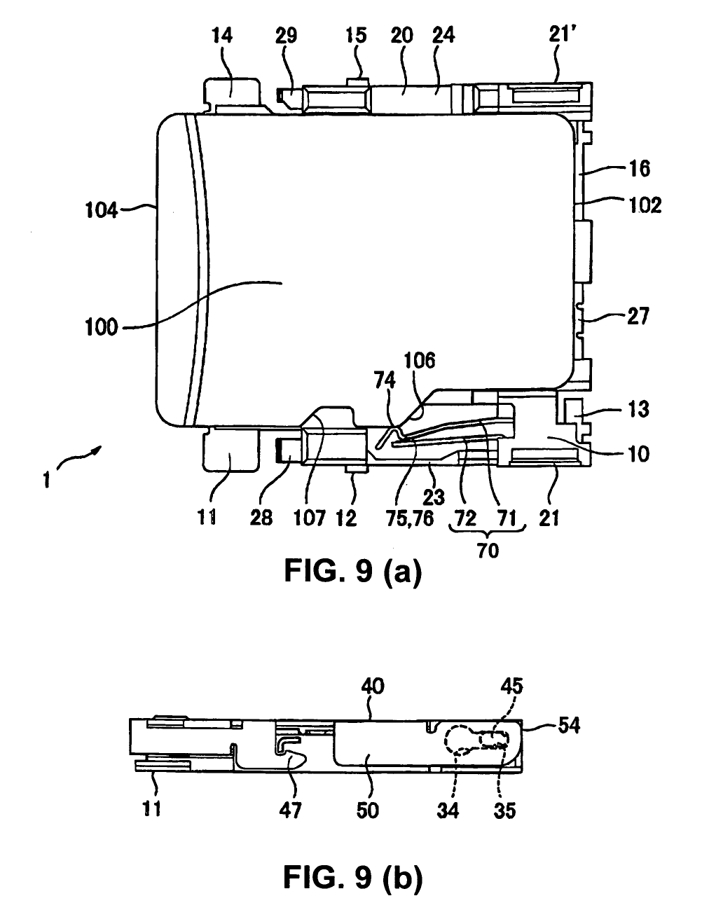

A vertical curve portion 53 is provided near a distal portion of the card locking piece 52. The vertical curve portion 53 engages with a specific position of the card 100 (engagement recess portion 107 shown in FIGS. 8 and 9) that is inserted into the card receptacle portion 42. Accordingly, the card 100 is prevented from coming off from the card receptacle portion 42.

A difference between a lock state and a unlock state will be explained with reference to FIGS. 6 and 7. In a state shown in FIG. 6 (in the lock state), the hook portions 47 and 47′ of the hinge cover 40 that turn an L-shape to an upper side are slid below lower sides of the locking pieces 12 and 15 of the base 10 that turn an L-shape to a lower side, respectively.

Further, the locking plates 44 and 44′ of the hinge cover 40 that extend in a horizontal direction are slid below lower sides of the locking pieces 28 and 29 that are similar to an S-shape of the base 10, respectively. As a result, when the hinge cover 40 is tried to rotate with respect to the base 10, a rotation is inhibited because these parts contact each other.

On the other hand, when the hinge cover 40 is in a state shown in FIG. 7 (in the unlock state), the hinge cover 40 can be freely open or close with respect to the base 10. When the hinge cover 40 is horizontally slid backward from the unlock state shown in FIG. 7 to the lock state shown in FIG. 6, or in other words, when the hinge cover 40 is horizontally slid toward the contact portion (74) of the card 100 and the first switch portion 71 while pivotally supported at approximately 0 degree with respect to the base 10, the hinge cover 40 is locked to the base 10.

On the other hand, when the hinge cover 40 is horizontally slid frontward from the state shown in FIG. 6 to the state shown in FIG. 7, the hinge cover 40 is unlocked from the base 10.

An operation of the detection switch 70 will be explained next with reference to FIGS. 8(a)-8(b) and 9(a)-9(b).

FIGS. 8(a) and 8(b) are views showing the card connector 1 in a state that the hinge cover 40 is not completely locked to the base 10 and the detection switch 70 does confirm an insertion of the card 100. FIGS. 9(a) and 9(b) are views showing the card connector 1 in a state that the hinge cover 40 is completely locked to the base 10 and the detection switch 70 confirms the insertion of the card 100. More specifically, FIGS. 8(a) and 9(a) are plan views of the card connector 1 with the card 100 inserted therein and without the hinge cover 40. FIGS. 8(b) and 9(b) are side views of the card connector 1 without the card 100.

As shown in the drawings, the detection switch 70 is situated near a pivotally support position of the hinge cover 40 and in a position in which the hinge cover 40 does not interfere with the card 100 simply by rotating with the card 100 (shown in FIG. 7), for example, a rear position of the card connector 1.

In the embodiment, the detection switch 70 comprises the first switch portion 71 and the second switch portion 72. The first switch portion 71 can be displaced by contacting a part of the card 100 when the hinge cover 40 and the card 100 are horizontally slid backward along the base 10. The second switch portion 72 is arranged to be adjacent to the first switch portion 71 and can be conducted by contacting the first switch portion 71 when the first switch portion 71 is displaced.

Whether or not the card 100 is inserted into the hinge cover 40 (card connector 1) can be detected through a conduction state between the first switch portion 71 and the second switch portion 72. The conduction state can be examined by taking out the electrical signal from the rear circuit board fixing portion 27 and the rear circuit board fixing portion 13 through an electric wiring or the like that is connected to the circuit board. The rear circuit board fixing portion 27 is electrically connected with the first switch portion 71. The rear circuit board fixing portion 13 is electrically connected with the second switch portion 72.

In the embodiment, the first switch portion 71 can extend frontward in a horizontal slide direction from, for example, a rear side (pivotally support side) of the arm portion 23 of the base 10. The first switch portion 71 has an inward curve portion 74 at a distal portion thereof and an outward curve portion 75.

The inward curve portion 74 can collide with a specific portion of the card 100 (step portion 106). The outward curve portion 75 can collide with the second switch portion 72 when displaced through a contact of the specific portion (step portion 106) of the card and the inward curve portion 74.

In the embodiment, the second switch portion 72 includes a contact pad 76 in a corresponding contact position to correspond to the outward curve portion 75 of the first switch portion 71.

The card 100 is a so-called micro SD card. The card 100 has a narrow width portion 102, a wide width portion 104, and the step portion 106. A contact pad (not shown) is arranged on a distal portion of the narrow width portion 102 along a horizontal slide direction.

The step portion 106 is situated between the narrow width portion 102 and the wide width portion 104. The narrow width portion 102 is a portion that extends in a direction perpendicular to the horizontal slide direction on the side of the contact portion (74) of the card 100 and the first switch portion 71 when the card is horizontally slid.

The wide width portion 104 is a portion that extends in a direction perpendicular to the horizontal slide direction on the opposite side of the contact portion (74) of the card 100 and the first switch portion 71.

The step portion 106 is a portion that is provided on a side surface of the card due to the length difference between the narrow width portion 102 and the wide width portion 104 in a direction perpendicular to the horizontal slide direction.

The first switch portion 71 is provided near the step portion 106 of the card 100 to be movable, for example, in a horizontal direction. As a result, when the unlock state shown in FIG. 8 is changed to the lock state shown in FIG. 9, in other words, when the card 100 is horizontally slid along the base 10 along with the hinge cover 40, the first switch portion 71 is displaced toward the second switch portion 72 side to contact the second switch portion 72 through a contact between a specific portion (step portion 106) of the card and the inward curve portion 74.

Further, the first switch portion 71 and the second switch portion 72 are conducted. Accordingly, an insertion of the card 100 is detected.

As described above, the detection switch 70 is activated through contacting the card 100 only when the hinge cover 40 is completely locked to the base 10; thereby the card 100 can be detected. That is, in the card connector 1, the detection switch 70 is not activated when the cover is simply downed, but is activated only when the card 100 is slid toward a rear portion and is completely fitted into the hinge cover 40.

Accordingly, the hinge cover 40 prevents the card 100 that is erroneously inserted into the hinge cover 40 from activating the detection switch 70. When the hinge cover 40 is at least completely locked to the base 10, the contact pad of the card 100 can also contact the contact 90 (not clearly shown in the drawings).

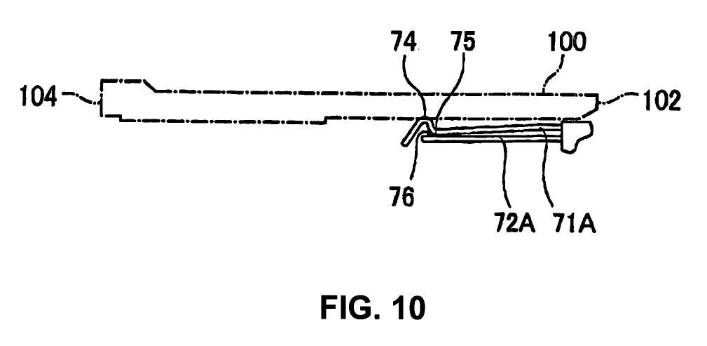

In the first embodiment described above, the detection switch portion 70 is provided to be movable in a horizontal direction. The detection switch portion 70 may be provided to be movable in a vertical direction at the same position of a lower portion of the card 100 as shown in FIG. 10. FIG. 10 is a side view showing the detection switch portion 70 according to the second embodiment of the present invention.

In the second embodiment, a first switch portion 71A collides with the step portion 106 of the card 100 to be pushed downward. Further, the first switch portion 71A contacts a second switch portion 72A that is arranged in a lower portion. The members in FIG. 10 corresponding to the members shown in FIGS. 8 and 9 or the like are assigned the same numbers.

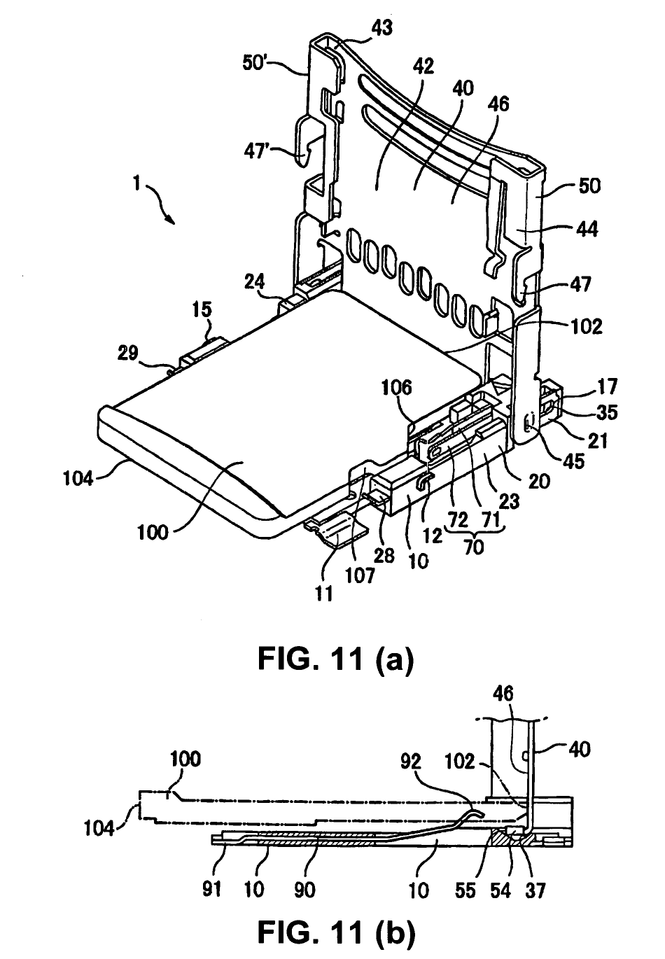

An operation of the error prevention mechanism of the card connector 1 will be explained with reference to FIGS. 11(a)-11(b) to 14(a)-14(b).

FIGS. 11(a) and 11(b) are views No. 1 showing the card connector 1 in an operation state according to the embodiment of the present invention, wherein FIG. 11(a) is a perspective view of the card connector 1, and FIG. 11(b) is a sectional view of the card connector taken along a centerline thereof in FIG. 11(a).

FIGS. 11(a) and 11(b) show a state in which the hinge cover 40 is pivotally supported at other than approximately 0 degree with respect to the base 10, for example, at approximately 90 degrees.

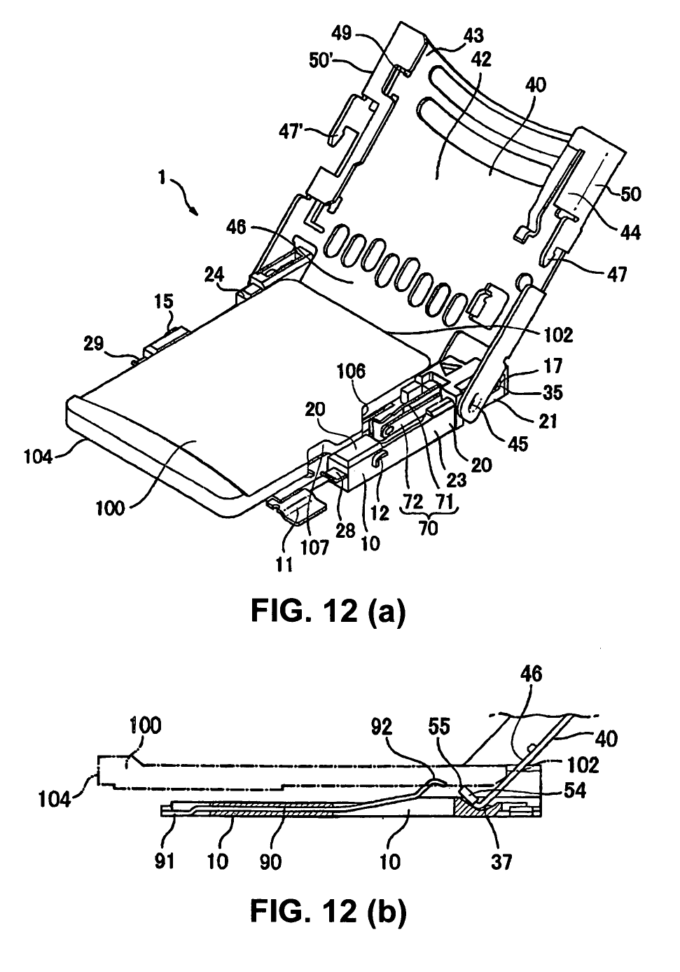

FIGS. 12(a) and 12(b) are views No. 2 showing the card connector 1 in the operation state according to the embodiment of the present invention, wherein FIG. 12(a) is a perspective view of the card connector 1, and FIG. 12(b) is a sectional view of the card connector 1 taken along the centerline thereof in FIG. 12(a).

FIGS. 12(a) and 12(b) show a state in which the hinge cover 40 is pivotally supported at other than approximately 180 degrees with respect to the base 10, for example, at approximately 135 degrees.

The hinge cover 40 is temporarily held by interfering the erect portion 54 thereof with an inclined surface 37 of the base 10 for an easier insertion of the card 100. It is especially preferred that the hinge cover 40 be temporarily held at approximately 90 degrees.

The hinge cover 40 is arranged on a side that is closer to the contact portion (74) of the card 100 and the first switch portion 71 than the long groove 35 of the base 10 (not shown in FIG. 6 but shown in FIG. 7) in a horizontal slide direction with respect to the base 10.

Under this positional relationship, when the card 100 that is not stored in the card receptacle portion 42 approaches the contact portion (74) of the card 100 and the first switch portion 71, the card 100 collides with an inner wall 46 of the base 10 side of the hinge cover 40 in the narrow width portion 102 of the front edge thereof; thereby the card 100 does not advance further to reach the contact portion (74) of the card 100 and the first switch portion 71.

Accordingly, the first switch portion 71 and the second switch portion 72 are not conducted through the card 100. As shown in FIG. 11, when the hinge cover 40 is pivotally supported at nearly an angle of approximately 90 degrees with respect to the base 10, near a distal 55 of the erect portion 54 of the hinge cover 40 contacts the inclined surface 37 provided in the base 10 to maintain the angle. When the angle is maintained, the card 100 can be inserted into the card receptacle portion 42 with ease.

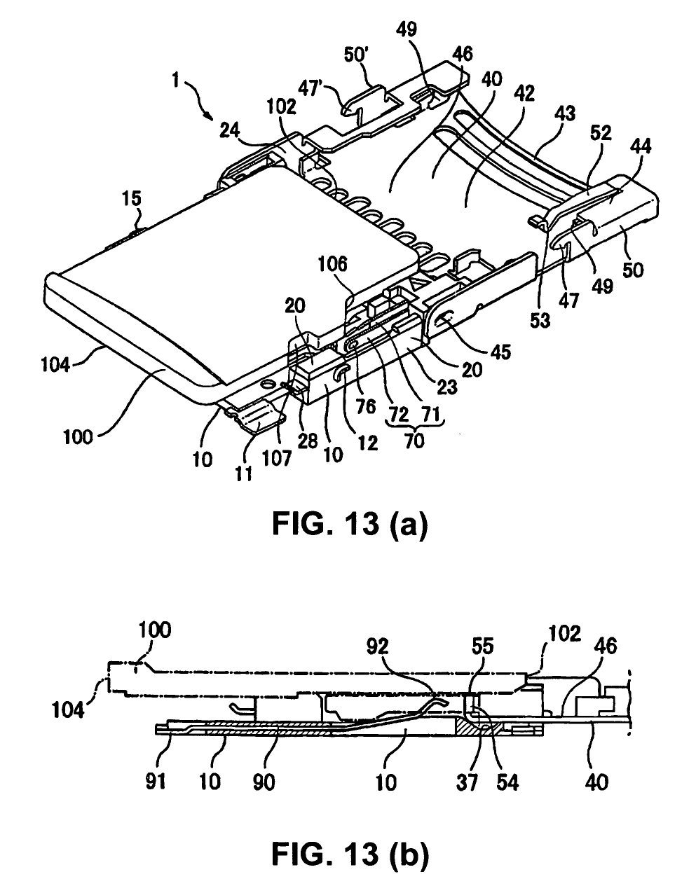

FIGS. 13(a) and 13(b) are views No. 3 showing the card connector 1 in the operation state according to the embodiment of the present invention, wherein FIG. 13(a) is a perspective view of the card connector 1, and FIG. 13(b) is a sectional view of the card connector 1 taken along the centerline thereof in FIG. 13(a).

FIGS. 13(a) and 13(b) show a state in which the hinge cover 40 is pivotally supported at approximately 180 degrees with respect to the base 10 and arranged on a side that is closer to the contact portion (74) of the card 100 and the first switch portion 71 than the long groove 35 of the base 10 (not shown in FIG. 6 but shown in FIG. 7) in a horizontal slide direction with respect to the base 10 in the similar manner as in FIGS. 11(a)-11(b) and 12(a)-12(b).

In this case, unlike the examples shown in FIGS. 11(a)-11(b) and 12(a)-12(b), the narrow width portion 102 of the card 100 that is not stored in the card receptacle portion 42 does not collide with the inner wall 46 of the base 10 side of the hinge cover 40. On the other hand, the card 100 that is not stored in the card receptacle portion 42 can collide with the distal 55 of the erect portion 54 of the hinge cover 40 and the back surface thereof.

The height of the erect portion 54 of the hinge cover 40 is approximately the same as a specific height, for example, the height of the first switch portion 71 and the second switch portion 72. In this case, too, the conduction between the first switch portion 71 and the second switch portion 72 through the card 100 is prevented. That is, a switch detection caused by a false insertion of the card can be prevented.

In FIGS. 12(a) and 12(b) described above, a switch detection caused by a false insertion of the card can be prevented using an operation error prevention mechanism of the distal 55 of the erect portion 54 of the hinge cover 40 explained with reference to FIG. 13 in addition to the operation error prevention mechanism of the inner wall 46 shown in 11(a) and 11(b).

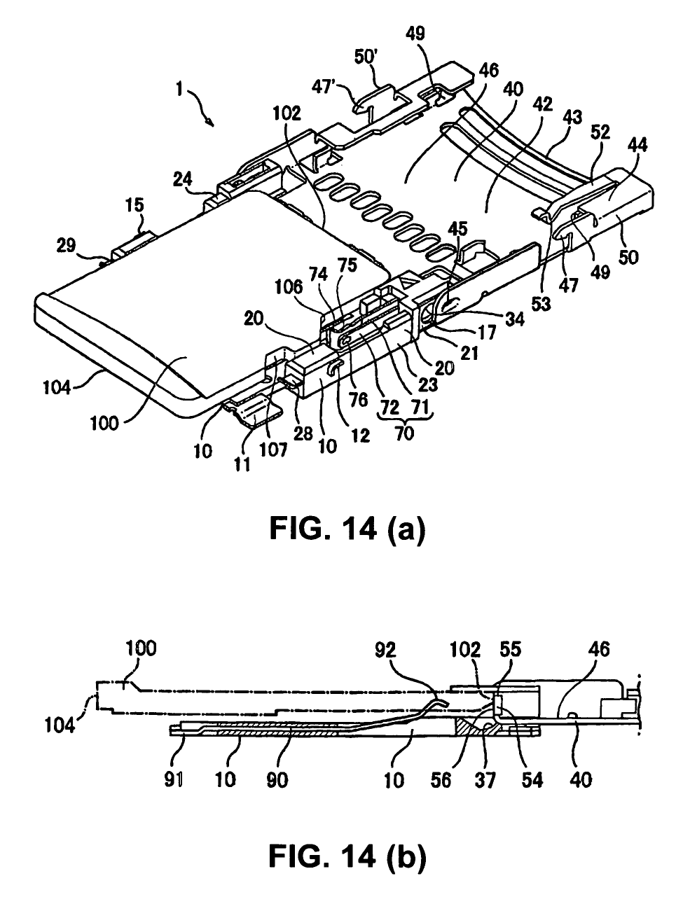

FIGS. 14(a) and 14(b) are views No. 4 showing the card connector 1 in the operation state according to the second embodiment of the present invention, wherein FIG. 14(a) is a perspective view of the card connector 1, and FIG. 14(b) is a sectional view of the card connector 1 taken along the centerline thereof in FIG. 14(a)

FIG. 14 shows a state in which the hinge cover 40 is pivotally supported at approximately 180 degrees with respect to the base 10 and is arranged on a back side of the long groove 35 of the base 10, or the opposite side of the contact portion (74) of the card 100 and the first switch portion 71 (the side not shown in FIG. 7 but shown in FIG. 6) in a horizontal slide direction with respect to the base 10.

In this case, too, unlike the cases shown in FIGS. 11(a)-11(b) and 12(a)-12(b), the narrow width portion 102 of the card 100 that is not stored in the card receptacle portion 42 does not collide with the inner wall 46 of the base 10 side of the hinge cover 40.

Instead, the protruding portion 45 of the hinge cover 40 and the long groove 35 of the base 10 function such that the hinge cover 40 is arranged on the side that is closer to the contact portion (74) of the card 100 and the first switch portion 71 in the long groove 35 of the base 10 for at least a length (indicated as “A” in FIG. 6) of the protruding portion 45 of the hinge cover 40 in a horizontal slide direction.

Accordingly, the card 100 that is not stored in the card receptacle portion 42 can collide with an outer surface 56 of the erect portion 54 of the hinge cover 40.

The height of the outer surface 56 of the erect portion 54 of the hinge cover 40 is approximately the same as a specific height, for example, the height of the first switch portion 71 and the second switch portion 72. Accordingly, in this case, too, the conduction between the first switch portion 71 and the second switch portion 72 through the card 100 can be prevented. That is, a switch detection caused by a false insertion of the card can be prevented.

As described above, a rotating shaft of the hinge cover 40 is arranged in a center-leaning position of the pivot supporting portion with respect to a card insertion longitudinal direction. Accordingly, the card does not contact the switch simply because the cover is downed. Instead, the switch is turned on only when the card 100 is completely inserted into the hinge cover 40. Accordingly, when the hinge cover 40 is pivotally supported at other than approximately 0 degree or 180 degrees, the hinge cover 40 prevents the card 100 from erroneously contacting the switch (first switch portion 71) to turn it on.

In the embodiments described above, the protruding portion is provided on the hinge cover 40 and the groove hole is provided on the base 10. Instead, the groove hole can be provided on the hinge cover 40 and the protruding portion can be provided on the base 10.

Further, the card 100 having the step portion 106 is used as an example of the above explanation. In addition, the present invention can be applied to a card having a shape other than what is described above. For example, the detection switch 70 can be provided in a position to collide with an edge of the card insertion side. Accordingly, a shape of the card used is not limited. Instead, the present invention can be applied to cards of a variety of shapes.

The present invention can be widely applied to devices (e.g. a cellular phone, etc.) that use a card.

The disclosure of Japanese Patent Application No. 2007-129331, filed on May 15, 2007, is incorporated in the application by reference.

While the invention has been explained with reference to the specific embodiments of the invention, the explanation is illustrative and the invention is limited only by the appended claims.

What is claimed is:

1. A card connector for connecting a card, comprising:
a base;
a cover pivotally supported on one end portion of the base to be freely rotatable and slidable along the base in a horizontal direction, said cover including a card receptacle portion for retaining the card;
a detection switch for contacting with and detecting the card retained in the card receptacle portion when the cover horizontally slides toward the one end portion of the base; and
a contact for contacting with the card.

2. The card connector according to claim 1, wherein said detection switch include a first switch portion and a second switch portion, said first switch portion being displaced upon contacting with the card, said second switch portion contacting and conducting with the first switch portion when the first switch portion is displaced to detect the card retained in the card receptacle portion.

3. The card connector according to claim 2, wherein said first switch portion is arranged such that the first switch portion contacts with the card on a side of the cover supported on the base in the horizontal direction.

4. The card connector according to claim 1, further comprising an erect portion on an edge of the cover, said erect portion extending toward the base.

5. The card connector according to claim 2, wherein said detection switch is arranged to detect the card having a narrow width portion extending in a direction perpendicular to the horizontal direction on a side thereof contacting with the first switch portion, a wide width portion on an opposite side thereof, and a step portion formed on a side surface of the card so that the first switch portion is disposed near the step portion to be movable in the horizontal direction or a vertical direction for contacting with the step portion and conducting with the second switch portion when the cover slides along the base.

6. The card connector according to claim 2, wherein said cover includes a protruding portion on an inner surface thereof, said protruding portion having a first length in the horizontal direction larger than a second length thereof in a direction perpendicular to the horizontal direction.

7. The card connector according to claim 6, wherein said base includes a circular hole and a long groove connected to the circular hole in an outer surface thereof, said circular hole having a first diameter large enough for the protruding portion to rotate, said long groove having a second diameter smaller than the first diameter and large enough for the protruding portion to slide in the horizontal direction so that the cover is slidable when the protruding portion is positioned in the circular hole and the cover is situated at an angle of approximately 0 degree or 180 degrees with respect to the base.

8. The card connector according to claim 4, wherein said base includes an inclined surface for contacting with the erect portion to maintain an angle of the cover with respect to the base when the cover is pivotally supported at an angle of 90 degrees with respect to the base.

9. The card connector according to claim 7, wherein said cover is arranged to be closer to a portion of the first switching portion contacting with the card relative to the long groove in the horizontal direction so that the card not retained in the card receptacle portion contacts with an inner surface of the cover and does not reach the portion when the cover is pivotally supported at an angle other than approximately 0 degree and 180 degrees with respect to the base.

10. The card connector according to claim 7, wherein said cover is arranged to be in the long groove closer to a portion of the first switching portion contacting with the card by a length of the protruding portion in the horizontal direction so that the card not retained in the card receptacle portion contacts with the erect portion and does not contact with the portion when the cover is pivotally supported at an angle of approximately 180 degree with respect to the base.

11. The card connector according to claim 2, wherein said base includes a protruding portion, said protruding portion having a first length in the horizontal direction larger than a second length thereof in a direction perpendicular to the horizontal direction.

12. The card connector according to claim 11, wherein said cover includes a circular hole and a long groove connected to the circular hole, said circular hole having a first diameter large enough for the protruding portion to rotate, said long groove having a second diameter smaller than the first diameter and large enough for the protruding portion to slide in the horizontal direction so that the cover is slidable when the protruding portion is positioned in the circular hole and the cover is situated at an angle of approximately 0 degree or 180 degrees with respect to the base.

13. The card connector according to claim 2, wherein said cover is arranged so that the cover locks to the base when the cover slides toward a portion of the first switch portion contacting with the card and is pivotally supported at an angle of approximately 0 degree with respect to the base.
